(19) United States
(12) Patent Application Publication
(10) Pub. No.: US 2012/0084564 A1
(43) Pub. Date: Apr. 5, 2012

(54) SECURITY OPERATION METHOD AND SYSTEM FOR ACCESS POINT

(75) Inventor: Young Jun CHOI, Hwasung-si (KR)

(73) Assignee: SAMSUNG ELECTRONICS CO. LTD., Suwon-si (KR)

(21) Appl. No.: 13/225,662

(22) Filed: Sep. 6, 2011

(30) Foreign Application Priority Data
Oct. 1, 2010 (KR) 10-2010-0095813

(51) Int. Cl. G06F 21/20; H04L 9/32

(52) U.S. Cl. 713/168; 726/7

(57) ABSTRACT

A system and a method of operating a security for an Access Point (AP) are provided. The method includes sending, by a mobile terminal, a key code conversion request message to the AP, generating, by the AP, a conversion key code in response to the key code conversion request message, sending, by the AP, the generated conversion key code to the mobile terminal, and accessing, by the mobile terminal, the AP based on the received conversion key code.

### PRIORITY

This application claims the benefit under 35 U.S.C. §119(a) of a Korean patent application filed on Oct. 1, 2010 in the Korean Intellectual Property Office and assigned Serial No. 10-2010-0095813, the entire disclosure of which is hereby incorporated by reference.

### BACKGROUND OF THE INVENTION

1. Field of the Invention

The present invention relates to a security operation for an Access Point (AP). More particularly, the present invention relates to a security operation system and method for an AP, which supports more robust security for the AP supporting wireless communication for a mobile terminal.

2. Description of the Related Art

The Institute of Electrical and Electronics Engineers (IEEE) 802.11 standard (i.e., a technical standard used in a Wireless Local Area Network (WLAN) and a computer wireless network for a local area called Wireless-Fidelity (Wi-Fi)) defines various technical standards so that devices can access a wired network through an Access Point (AP).

A mobile terminal includes a mobile communication module for using a wireless communication system and can support the establishment of a communication channel with other mobile terminals based on the wireless communication system. The mobile terminal further includes a Wi-Fi module for supporting Wi-Fi and can support a wired network access function.

The AP and the mobile terminal perform communication according to certain rules. Various methods are used for the security of data transmitted and received in the communication process. In the AP to which the mobile terminal gains access wirelessly, the first installed state is used and rarely changed. If the first installed state continues to be used in the AP, there is a problem in that a person who has obtained unchanged security information about the AP may use the security information maliciously.

Therefore, a need exists for a security operation system and method for an AP, which supports more robust security for the AP supporting wireless communication for a mobile terminal.

### SUMMARY OF THE INVENTION

Aspects of the present invention are to address at least the above-mentioned problems and/or disadvantages and to provide at least the advantages described below. Accordingly, an aspect of the present invention is to provide a security operation system and method for an Access Point (AP).

Another aspect of the present invention is to provide a security operation system and method for an AP, which are capable of maintaining and managing a more stable security state.

In accordance with an aspect of the present invention, a security operating method for an AP is provided. The method includes sending, by a mobile terminal, a key code conversion request message to the AP, generating, by the AP, a conversion key code in response to the key code conversion request message, sending, by the AP, the generated conversion key code to the mobile terminal, and accessing, by the mobile terminal, the AP based on the received conversion key code.

In accordance with another aspect of the present invention, a security operation system for an AP is provided. The system includes a mobile terminal for generating a key code conversion request message, for sending the key code conversion request message to the AP, and, when a conversion key code corresponding to the key code conversion request message is received from the AP, for attempting access to the AP based on the conversion key code, and the AP for generating a new conversion key code in response to a key code conversion request of the mobile terminal and for sending the new conversion key code to the mobile terminal.

The AP includes an AP input unit for changing a communication state of the AP, an AP communication unit for performing communication with the mobile terminal, an AP storage unit for storing an encryption algorithm for a security operation and an access history of the mobile terminal, and an AP controller for, when the key code conversion request is received from the mobile terminal, generating the new conversion key code based on the encryption algorithm and sending the new conversion key code to the mobile terminal.

In accordance with the security operation system and method for an AP according to the exemplary embodiments of the present invention, a key code used in the security of an AP is converted through a simple control operation. Accordingly, more robust communication against hacking or data snipping can be supported.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a configuration of a security operation system for an Access Point (AP) according to an exemplary embodiment of the present invention;

FIG. 2 is a block diagram illustrating a configuration of an AP according to an exemplary embodiment of the present invention;

FIG. 3 is a block diagram illustrating a configuration of a mobile terminal according to an exemplary embodiment of the present invention;

FIG. 4 is a diagram illustrating a transmission and reception of signals between an AP and a mobile terminal for a security operation according to an exemplary embodiment of the present invention; and

FIG. 5 is a flowchart illustrating a method of operating a mobile terminal for a security operation according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

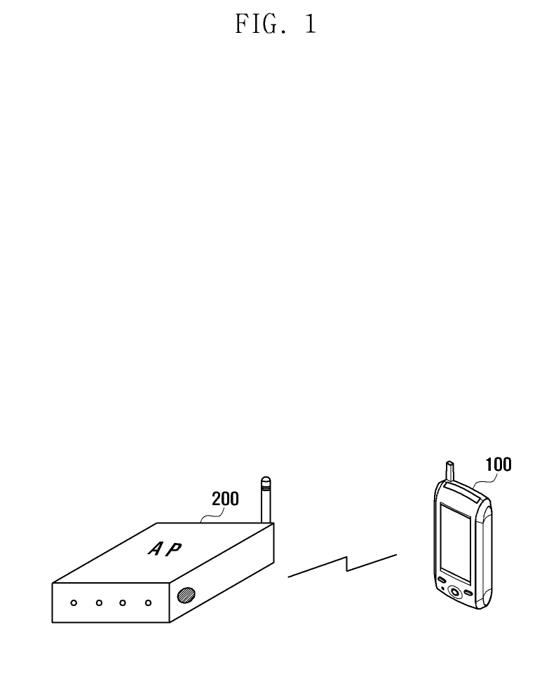

FIGS. 1 through 5, described below, and the various exemplary embodiments of the present invention provided are by way of illustration only and should not be construed in any way that would limit the scope of the present invention. Those skilled in the art will understand that the principles of the present disclosure may be implemented in any suitably arranged communications system. The terms used to describe various exemplary embodiments of the present invention provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 1 illustrates a configuration of a security operation system for an Access Point (AP) according to an exemplary embodiment of the present invention.

Referring to FIG. 1, the security operation system may include an AP 200 and a mobile terminal 100. The security operation system may further include a network configured to have the AP 200 access thereto through a wired connection, a server connected to the network, and the like. However, only the elements of the AP and the mobile terminal for a security operation are described below.

In the security operation system constructed as above, the conversion key code of the AP 200 can be randomly converted based on specific information, provided by the mobile terminal 100, through a simple control operation by the AP 200 and the mobile terminal 100. The AP 200 and the mobile terminal 100 can share the converted key code. Accordingly, the security operation system can support more robust data transmission and reception by randomly changing the conversion key code of the AP 200. Each of the elements is described below.

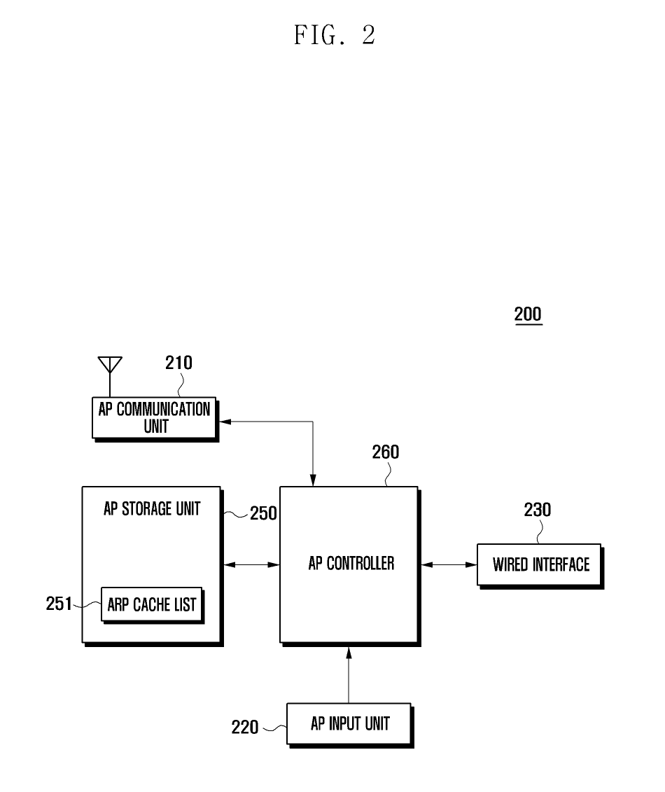

The AP 200 is an element to which the mobile terminal 100 can gain access wirelessly. The AP 200 can access a network through at least one of a wired and wireless connection. When the mobile terminal 100 accesses the network, a specific address value is allocated to the mobile terminal 100 so that data transmitted by the mobile terminal 100 can be transmitted to a specific server or other mobile terminals which have accessed the network. More particularly, the AP 200 may perform control in response to a key code conversion request made by the mobile terminal 100 so that a specific conversion key code is generated based on specific information gathered from the mobile terminal 100. Here, the AP 200 can provide a button for converting the conversion key code and support a change of a communication state when the button is activated. Furthermore, when the conversion key code is generated, the AP 200 can send the generated conversion key code to the mobile terminal 100 and support the transmission and reception of encrypted data based on the conversion key code. A configuration of the AP 200 is described below with reference to FIG. 2.

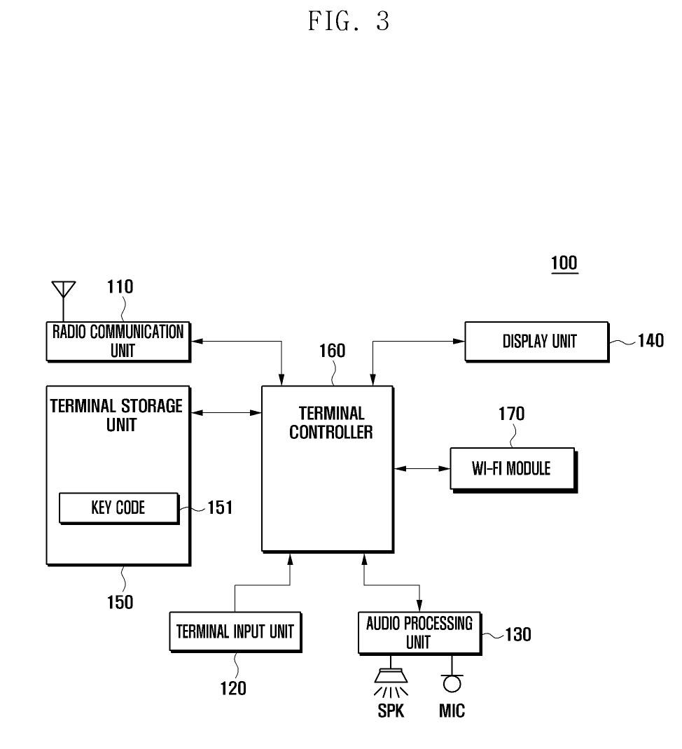

The mobile terminal 100 may wirelessly access a network through the AP 200. The mobile terminal 100 provides a communication module for accessing the AP 200. Furthermore, the mobile terminal 100 can encrypt data to be transmitted to the AP 200 based on a previously stored key code. More particularly, the mobile terminal 100 can send a message, requesting to convert the key code of the AP 200, to the AP 200 according to the state of the AP 200. Furthermore, when the conversion key code is received from the AP 200, the mobile terminal 100 supports the encryption of data to be transmitted to the AP 200 based on the received conversion key code. A configuration of the mobile terminal 100 and elements thereof are described with reference to FIG. 3.

As described above, the security operation system according to the exemplary embodiment of the present invention can support easy conversion and an easy operation for a key code, used in encryption communication between the AP 200 and the mobile terminal 100, through a simple control operation by the AP 200 and the mobile terminal 100.

FIG. 2 is a block diagram illustrating a configuration of an AP according to an exemplary embodiment of the present invention.

Referring to FIG. 2, an AP 200 may include an AP communication unit 210, an AP input unit 220, a wired interface 230, an AP storage unit 250, and an AP controller 260.

The AP 200 including the above elements performs the transmission and reception of data and signals used for wireless communication with the mobile terminal 100 through the AP communication unit 210. More particularly, the AP 200 can change a communication state into an “OPEN” communication state when a state change request signal used to convert a key code is received through the AP input unit 220 and can perform control according to whether a key code conversion request signal has been received from the mobile terminal 100 so that a new conversion key code is generated. Here, the “OPEN” communication state is a communication state without an additional encryption process, and there may be various states in which the mobile terminals 100 can be accessed. That is, the “OPEN” communication state is a state in which a specific mobile terminal 100 can be accessed according to the access history of the mobile terminal 100. The configuration and function of each of the elements of the AP 200 are described below.

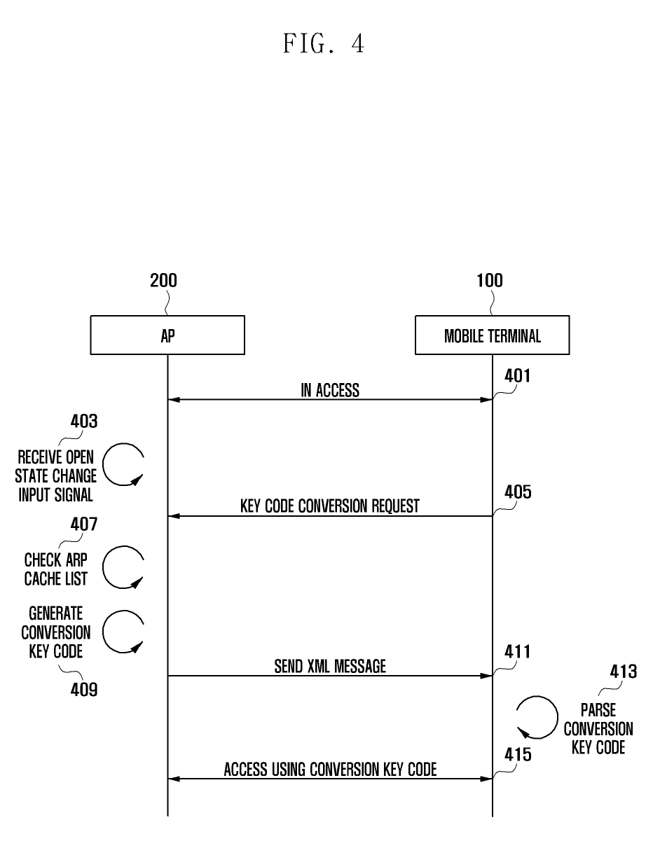

The AP communication unit 210 is an element for performing communication with the mobile terminal 100 under the control of the AP controller 260. The AP communication unit 210 is a communication module capable of performing communication with a specific communication module (e.g., a Wireless-Fidelity (Wi-Fi) module) provided in the mobile terminal 100 and is an element capable of performing communication according to Wi-Fi transmission and reception rules. When an access request message is received from the mobile terminal 100, the AP communication unit 210 can transfer the message to the AP controller 260 and send network address information for wireless communication with the mobile terminal 100 to the mobile terminal 100. The AP communication unit 210 may be set in various communication states under user control or under the control of the AP controller 260. For example, the AP communication unit 210 may have an “OPEN” communication state, a “Wired Equivalent Privacy (WEP) encryption” communication state, a “Wi-Fi Protected Access (WPA) encryption” communication state, or a “WPA2 encryption” communication state. Accordingly, the mobile terminal 100 has a restriction to access to the AP 200 according to the setting state of the AP communication unit 210. That is, if the AP communication unit 210 is in the “OPEN” communication state, the mobile terminal 100 can send data to the AP 200 without an additional restriction. If the AP communication unit 210 is in the “WEP, WPA, or WPA2” encryption communication state, the mobile terminal 100 may normally send signals or data to the AP communication unit 210 only when the signal or data is encrypted based on a key code suitable for relevant encryption. In an exemplary implementation, the AP communication unit 210 may have the encryption communication state after the “OPEN” communication state under user control for the security operation of the AP. A change of the communication state is described below with reference to FIG. 4.

The AP input unit 220 is an element capable of generating an input signal for controlling the AP 200 and may include buttons, and the like. The AP input unit 220 may include a button for turning on or off the AP 200. More particularly, the AP input unit 220 may provide a button for changing the communication state of the AP communication unit 210. In order to convert the key code of the AP 200, a user may change the communication state of the AP communication unit 210 into the “OPEN” communication state using the AP input unit 220.

The wired interface 230 is an element for enabling the AP 200 to transfer data, received from the mobile terminal 100, to a network. The wired interface 230 may become an interface to which a cable for connecting the network and the AP 200 together is connected. The wired interface 230 may be configured to be connected to a port provided in the cable or may be fabricated in the form of a structure (e.g., a hook) for supporting the cable more firmly after the cable is connected.

The AP storage unit 250 is an element for storing various application programs used to operate the AP 200. More particularly, the AP storage unit 250 stores an encryption program for a security operation. The encryption program may include encryption algorithms, such as WEP, WPA, and WPA2, a key code generation routine for generating a key code used to transmit and receive data based on the encryption algorithm, a transmission routine for sending the generated key code to the mobile terminal 100, a routine for decoding data based on the generated key code when the data is received from the mobile terminal 100, and the like. The key code generation routine may include a sub-routine for gathering specific information about the mobile terminal 100 (i.e., the Media Access Control (MAC) address value of the mobile terminal 100) and at least one of time information about the time when the mobile terminal 100 has sent a key code conversion request message and time information about the time when the mobile terminal 100 was finally accessed, when the key code conversion request message is received from the mobile terminal 100, and a sub-routine for generating a conversion key code based on the gathered MAC address value, the time information, and the encryption algorithm. Here, the sub-routine for generating the conversion key code generates the conversion key code by applying at least one of the MAC address value and the time information to the encryption algorithm. The MAC address value, the time information, and the like, may be used as parameters for generating a unique conversion key code.

Furthermore, the AP storage unit 250 can store information (i.e., an Address Resolution Protocol (ARP) cache list 251) about a plurality of the accessed mobile terminals 100. The ARP cache list 251 is a list including access information (i.e., an access history) about the mobile terminals 100 and may be stored along with the MAC addresses of the mobile terminals 100. The ARP cache list 251 may also include time information about the time when the mobile terminal 100 was accessed and time information about the time when the key code conversion request message was received. The pieces of information may be used in the process of the encryption program generating a key code. Meanwhile, the AP storage unit 250 may store a conversion key code value for a specific mobile terminal 100 and may store a plurality of conversion key code values according to the security operations of a plurality of the mobile terminals 100.

The AP controller 260 resets each of the elements and supports a security operation through the operation of the elements and the wireless communication relay of the mobile terminal 100. When an input signal (i.e., a communication state change input signal) for a security operation is received from the AP input unit 220, the AP controller 260 may perform control so that the communication state of the AP communication unit 210 of the AP 200 is changed into the “OPEN” communication state. Thereafter, the AP controller 260 determines whether a key code conversion request message is received from the mobile terminal 100. If, as a result of the determination, the key code conversion request message is received, the AP controller 260 may check the ARP cache list 251 stored in the AP storage unit 250 in order to determine whether the mobile terminal 100 has an access history or the mobile terminal 100 had been accessed. Furthermore, if the mobile terminal 100 satisfies a relevant condition, the AP controller 260 performs control based on specific information about the mobile terminal 100 (e.g., the MAC address value of the mobile terminal 100) and at least one of the access time information and the key code conversion request message transmission time information so that a new conversion key code is generated. When the new conversion key code is generated, the AP controller 260 may perform control so that the new conversion key code is converted according to a certain data format and transmitted to the mobile terminal 100. When data and signals are received from the mobile terminal 100, the AP controller 260 may perform control so that the received data and signal are decoded based on the new conversion key code and operations (i.e., data transmission and relay) corresponding to the received data and signal are performed. Here, the AP controller 260 may perform control so that the new conversion key code is stored in the AP storage unit 250. Meanwhile, the AP controller 260 may perform control so that a communication state is changed, that is, the ARP cache list 251 of the AP storage unit 250 is updated by parsing a MAC address and access time information about the mobile terminal 100 which accesses the AP 200 in the “OPEN” communication state.

As described above, the AP 200 generates a key code value, used in the process of performing communication with the mobile terminal 100, based on information about the mobile terminal 100 and supports security communication so that it can be performed based on the generated key code value. Accordingly, robust data communication against hacking or snipping can be supported because the key code value of the AP 200 can be simply updated at the request of the mobile terminal 100. Here, the routine for selecting one of the WEP, WPA, and WPA2 encryption algorithms may be changed under the control of the AP 200 designer or operator.

FIG. 3 is a block diagram illustrating a configuration of a mobile terminal according to an exemplary embodiment of the present invention.

Referring to FIG. 3, a mobile terminal 100 may include a radio communication unit 110, a terminal input unit 120, an audio processing unit 130, a display unit 140, a terminal storage unit 150, a terminal controller 160, and a Wi-Fi module 170.

The mobile terminal 100 including the above elements can access the AP communication unit 210 based on the Wi-Fi module 170 and support the encryption of data and signals to be transmitted to the AP communication unit 210 by using a previously stored key code or an updated conversion key code. Furthermore, the mobile terminal 100 can generate a key code security request message, requesting the AP 200 to convert a key code, under user control and send the generated key code security request message to the AP 200. When the conversion key code is received from the AP 200 in response to the key code conversion request message, the mobile terminal 100 may perform control so that data and signals transmitted to the AP 200 are encrypted based on the relevant conversion key code. Each of the elements of the mobile terminal 100 is described below.

The radio communication unit 110 forms a communication channel for a voice call and sends an image or video or forms a communication channel for data transmission under the control of the terminal controller 160. That is, the radio communication unit 110 forms the voice call channel, the data transmission channel, the video telephony channel, and the like, with the wireless communication system. To this end, the radio communication unit 110 may include a radio frequency transmission unit for performing up-conversion and amplification for the frequency of a transmitted signal, a radio frequency reception unit for performing low-noise amplification and down-conversion for the frequency of a received signal. The radio communication unit 110 is an element which is used when the mobile terminal 100 supports a mobile communication function and may be omitted when the mobile terminal 100 does not support the mobile communication function. Furthermore, the radio communication unit 110 may support the establishment of a communication channel with a network to which the AP 200 has gained access according to whether a function is supported.

The terminal input unit 120 includes a plurality of input keys and function keys for receiving number or character information and setting various functions. The function keys may include direction keys, side keys, hot keys, and the like, which are set to perform specific functions. Furthermore, the terminal input unit 120 generates a key signal in regard to user setting and control of the functions of the mobile terminal 100 and sends the key signal to the terminal controller 160. More particularly, the terminal input unit 120 can generate an input signal for communication with the AP 200 and an input signal for generating a key code conversion request message indicating the generation of a conversion key code based on the AP 200. The generated input signals can be transferred to the terminal controller 160.

The audio processing unit 130 includes a speaker SPK for playing an audio signal according to the play of specific content and an audio signal transmitted and received after a communication channel is formed and a microphone MIC for gathering a user's voice or other audio signals when a call is performed. More particularly, the audio processing unit 130 can output a relevant alarm or guidance voice when an event related to a key code converted by the AP 200 is generated. For example, when an alarm or a guidance voice according to the success or failure of access in a process of accessing the AP 200 based on the Wi-Fi module 170 or a message including a conversion key code is received from the AP 200, the audio processing unit 130 can output a relevant alarm, a relevant guidance voice, and the like. The output of the alarm or guidance voice may be omitted according to the setting of the mobile terminal 100.

The display unit 140 displays information inputted by a user, information provided to a user, and the like, in addition to various menus provided by the mobile terminal 100. That is, the display unit 140 can provide various screens (e.g., a standby screen, a menu screen, a message writing screen, and a call screen) according to the use of the mobile terminal 100. The display unit 140 may be a display device to which a Liquid Crystal Display (LCD), a flat display device, such as an Organic Light Emitted Diode (OLED), or a thin film transistor device is applied. Furthermore, if the display unit 140, together with a touch panel, is fabricated in the form of a touch screen, the display unit 140 can perform functions as an input unit. In this case, the display unit 140 can output an icon for requesting the generation of a key code which is used for the security operation of the AP 200. That is, the display unit 140 may output a key code conversion request icon in the form of a menu item, a soft key icon, a hot key icon, and the like. Accordingly, a user can control the generation of a message for the key code conversion request by using the icon or menu item outputted in the display unit 140. Meanwhile, the display unit 140 can output a screen according to the access state of the AP 200, a screen according to a key code conversion process based on the AP 200, a screen according to the re-access state of the AP 200, and the like, based on the Wi-Fi module 170. The screen according to the key code conversion process may include a screen for sending the key code conversion request message to the AP 200, a screen for receiving a message, including a conversion key code, from the AP 200, and the like. Furthermore, the screen according to the key code conversion process may include a screen, including a message or an icon corresponding to a communication state (e.g., the “OPEN” communication state) of the AP 200 in a process of accessing the AP 200.

The terminal storage unit 150 can store the application programs used for the security operation of the AP 200 as well as application programs used for the functions and the operations according to an exemplary embodiment of the present invention function. The storage unit 150 may include a program region and a data region.

The program region stores an Operating System (OS) for booting the mobile terminal 100, application programs used for optional functions (e.g., a sound play function and an image or video play function) of the mobile terminal 100, and the like. More particularly, the program region can store a key code program for the security operation of the AP 200.

The key code program may include a routine for providing a previously stored key code value when the mobile terminal 100 attempts to access the AP 200, a routine for generating a key code conversion request message in response to an input signal generated by the terminal input unit 120, a transmission routine for sending the generated key code conversion request message to the AP 200, a routine for receiving a message including a conversion key code from the AP 200, a routine for parsing the conversion key code from the received message, a routine for performing re-access to the AP 200 based on the extracted conversion key code, and the like. The transmission routine may include a sub-routine for determining whether the communication state of the AP 200 is the “OPEN” communication state and a sub-routine for, if the communication state of the AP 200 is not the “OPEN” communication state as a result of the determination, informing that the communication state of the AP 200 is not the “OPEN” communication state. The key code program may be loaded into the terminal controller 160 when the Wi-Fi module 170 of the mobile terminal 100 is activated, and thus it may support for performing the function for the security operation of the AP.

The data region is a region for storing data generated when the mobile terminal 100 is used. The data region can store data recorded by a user when a call is performed, user data (e.g., video) related to various option functions provided by the mobile terminal 100, phonebook data, audio data, and pieces of information corresponding to relevant content or user data. More particularly, the data region stores a key code 151 for accessing the AP 200. The key code 151 can be updated according to a conversion key code received from the AP 200.

The Wi-Fi module 170 forms a communication channel according to a communication state provided by the AP 200 and performs data transmission under the control of the terminal controller 160. Here, the Wi-Fi module 170 can perform control under the control of the terminal controller 160 so that data or signals to be transmitted are encrypted with reference to the key code 151 stored in the terminal storage unit 150 and the encrypted data and the signals are transmitted to the AP 200. More particularly, the Wi-Fi module 170 can send a key code conversion request message to the AP 200 and receive a message, including the conversion key code, from the AP 200. Furthermore, the Wi-Fi module 170 can send the MAC address value of the mobile terminal 100 to the AP 200 in a process of the mobile terminal 100 first accessing the AP 200.

The terminal controller 160 controls the supply of power to each of the elements of the mobile terminal 100 and also supports a reset process. After the reset process is completed, the terminal controller 160 can control the flow of a signal for accessing the AP 200 at the request of a user. Furthermore, the terminal controller 160 may control the flow of a signal for supporting the security operation of the AP 200 according to an exemplary embodiment of the present invention. When an input signal for a key code conversion request is received from the terminal input unit 120, the terminal controller 160 can generate a key code conversion request message and send the generated key code conversion request message to the AP 200 through the Wi-Fi module 170. Furthermore, when a message including a converted key code value is received from the AP 200, the terminal controller 160 can parse the converted key code value from the received message and perform control so that the key code 151 stored in the terminal storage unit 150 is updated based on the parsed key code value. Furthermore, the terminal controller 160 can control the transmission and reception of signals for re-accessing the AP 200 based on the converted key code value and perform control so that specific data or signals are encrypted into the converted key code value under user control and transmitted to the AP 200.

As described above, the mobile terminal 100 may instruct the AP 200 to generate a new key code in response to a key input signal which is set to perform a simple control operation (e.g., a key code conversion request). Furthermore, the mobile terminal 100 supports robust security communication based on a unique key code value which is generated by the AP 200 based on specific information (e.g., a MAC address value) about the mobile terminal 100 and at least one of time information about the time when the mobile terminal 100 accesses the AP 200 and time information about the time when a key code conversion request message was sent.

FIG. 4 is a diagram illustrating a transmission and reception of signals between an AP and a mobile terminal for a security operation according to an exemplary embodiment of the present invention.

Referring to FIG. 4, first, an AP 200 and a mobile terminal 100 may maintain a connection state at step 401. This process is a certain process which is previously set and may be a process for the access history of the mobile terminal 100 to the AP 200. Accordingly, if there is a history in which the mobile terminal 100 has accessed the AP 200, step 401 may be omitted.

At step 403, a user may control the security operation system so that a communication state is changed by activating the communication state change button provided in the AP input unit 220 of the AP 200. The AP 200 may perform control so that the communication state of the AP 200 is changed into the “OPEN” communication state. The reason why the communication state of the AP 200 is changed into the “OPEN” communication state is to enable the mobile terminal 100 to access the AP 200 without any restriction. Accordingly, if the mobile terminal 100 and the AP 200 are communicating with each other based on specific encryption or are previously set to communicate with each other, step 403 may be omitted. If at least one of step 401 and step 403 exists, the mobile terminal 100 may perform the next step.

At step 405, the mobile terminal 100 sends a request to the AP 200 to convert a key code. To this end, the user of the mobile terminal 100 may generate an input signal for the key code conversion request. When the input signal is generated, the terminal controller 160 may write a message including the key code conversion request and send the message to the AP 200. Here, the key code conversion request message is a command that instructs the AP 200 to generate a new key code value. At least one of previously agreed signals with various forms may be set as the new key code value. For example, the key code conversion request message may be an “Association” command that enables the mobile terminal 100 to request access to the AP 200 again with the mobile terminal 100 being connected to the AP 200.

When the key code conversion request message (e.g., the “Association” command) is received from the mobile terminal 100, the AP 200 determines whether the mobile terminal 100 sending the key code conversion request message is a terminal having an access history by checking the ARP cache list at step 407. Here, step 407 is a process of determining whether the mobile terminal 100 accessing the AP 200 at step 401 is sending the “Association” command. Accordingly, if the mobile terminal 100 and the AP 200 have previously set a specific key code conversion request message in order to perform key code conversion, step 407 may be omitted.

Thereafter, the AP 200 generates a conversion key code at step 409. In this process, the AP 200 may perform control so that the new conversion key code is generated based on a specific encryption algorithm with reference to the MAC address of the mobile terminal 100, access time information about the mobile terminal 100, and the like, based on the access history of the mobile terminal 100. Here, the process of the AP 200 gathering the MAC address of the mobile terminal 100 may be performed by gathering the MAC address from the ARP cache list, previously obtained and stored at step 401, or by gathering the MAC address in the process of sending the key code conversion request message at step 405. To this end, the mobile terminal 100 may send information about the MAC address to the AP 200 at steps 401 and 405.

Thereafter, the AP 200 may write a message (e.g., an eXtensible Markup Language (XML) Info message) for storing the new conversion key code and send the written XML Info message to the mobile terminal 100 at step 411. Here, the format of the XML Info message is an example of a transmission format of data which is transmitted and received between the AP 200 and the mobile terminal 100 and may be changed according to other transmission formats.

When the mobile terminal 100 receives the message in which the new conversion key code is stored from the AP 200, the mobile terminal 100 parses the new conversion key code from the message at step 413. Furthermore, the mobile terminal 100 may perform control so that it accesses the AP 200 again based on the new conversion key code at step 415. Furthermore, the mobile terminal 100 may perform control so that the new conversion key code is stored in the terminal storage unit 150.

In the description of FIG. 4, the security operation process has been illustrated to include step 403, providing an environment in which the mobile terminal 100 can access the AP 200 without a restriction and also illustrated to include step 407 in which the mobile terminal 100 checks the ARP cache list in order to use the “Association” command (i.e., an access command used to access the AP 200 at step 405). It is to be understood that steps 401, 403, and 407 may be selectively operated according to an information transfer method for the key code conversion request. Consequently, the flow of signals for the security operation may briefly include the process of the mobile terminal 100 sending the key code conversion request message to the AP 200 in the state in which the AP 200 is accessible to the mobile terminal 100, the process of the AP 200 generating the conversion key code in response to the key code conversion request message, the process of the AP 200 sending the generated conversion key code to the mobile terminal 100, and the process of the mobile terminal 100 accessing the AP 200 based on the conversion key code.

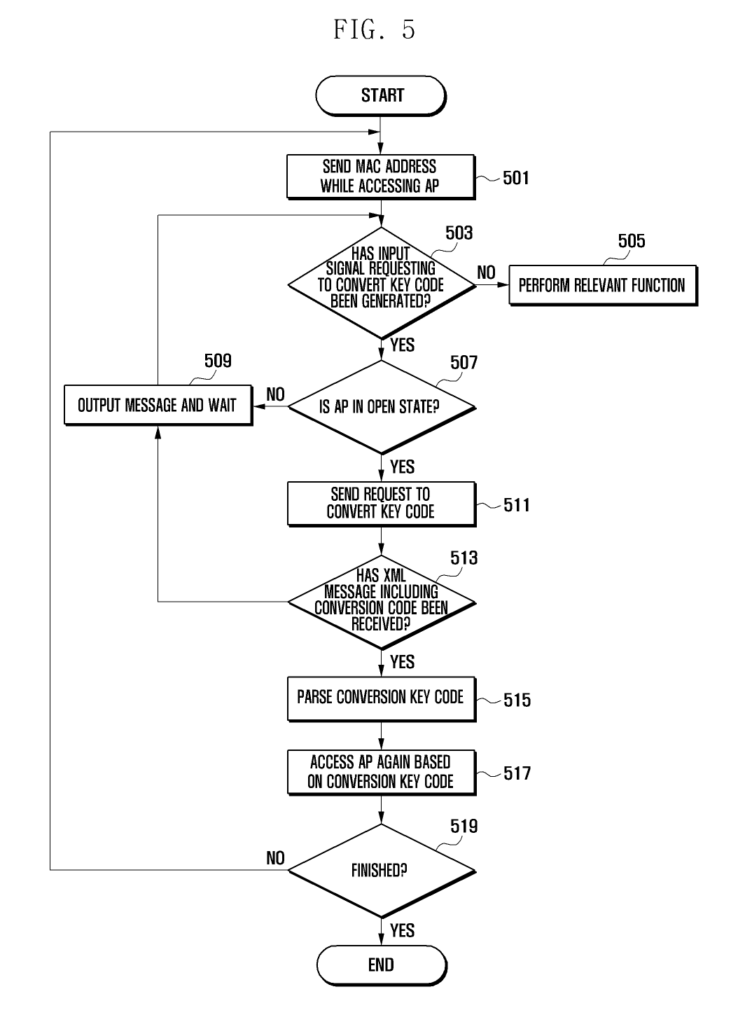

FIG. 5 is a flowchart illustrating a method of operating a mobile terminal for a security operation according to an exemplary embodiment of the present invention.

Referring to FIG. 5, in the method of operating the mobile terminal for the security operation of the AP, first, when power is supplied, the terminal controller 160 may complete a reset process for each of the elements of the mobile terminal 100 by using the supplied power and perform control so that the mobile terminal 100 accesses the AP 200 under user control. Accordingly, the mobile terminal 100 may be in the access state to the AP 200 at step 501. In this process, the mobile terminal 100 can send a MAC address to the AP 200.

Thereafter, the mobile terminal 100 can determine whether an input signal, requesting the AP 200 to convert a key code, has been generated at step 503. If, as a result of the determination, an input signal, requesting the AP 200 to convert a key code, has not been generated, the mobile terminal 100 can perform a function corresponding to the input signal at step 505. That is, the mobile terminal 100 may perform a file play function, a file search function, Internet access and search functions, a call function supported by the mobile terminal 100, a network function to access the AP 200, and the like, in response to the input signal.

In contrast, if it is determined at step 503 that an input signal, requesting the AP 200 to convert a key code, has been generated, the mobile terminal 100 can determine whether the AP 200 is in the “OPEN” communication state at step 507. If, as a result of the determination, the AP 200 is not in the “OPEN” communication state, the mobile terminal 100 may output a relevant message and stand by for some time at step 509 and return to step 503. To determine whether the AP 200 is in the “OPEN” communication state is to determine whether the mobile terminal 100 can access the AP 200 without a special restriction. Accordingly, if the mobile terminal 100 can access the AP 200 based on encryption, step 507 may be omitted.

In contrast, if it is determined at step 507 that the AP 200 is in the “OPEN” communication state or the AP 200 is accessible to the mobile terminal 100, the mobile terminal 100 can perform control so that a key code conversion request signal is transmitted to the AP 200 at step 511.

Thereafter, the mobile terminal 100 can determine whether a message including the conversion key code has been received from the AP 200 at step 513. In the process of sending the message including the conversion key code, the AP 200 may send the message in the form of data having a specific data format (e.g., an XML format). The mobile terminal 100 can determine whether the XML message has been received from the AP 200 at step 513 and determine whether a conversion key code value is included in the received XML message. If a conversion key code value is not included in the received XML message or the XML message including the conversion key code is not received, the mobile terminal 100 may output a message corresponding to the case in which the conversion key code is not received at step 509 and return to step 503.

In contrast, if it is determined at step 513 that the message including the conversion key code has been received from the AP 200, the mobile terminal 100 parses the conversion key code value from the message at step 515. The mobile terminal 100 may then access the AP 200 again based on the conversion key code value at step 517. Thereafter, the mobile terminal 100 may determine whether an input signal for finishing access to the AP 200 has been generated at step 519. If, as a result of the determination at step 519, the input signal for finishing access to the AP 200 has been not generated, the mobile terminal 100 may return to step 501 so that the functions according to access to the AP are performed at step 505 via step 503.

In the above description, step 501 is an added process for enabling the AP 200 to determine a key code conversion request message using the ARP cache list as described above with reference to FIG. 4. Accordingly, if the mobile terminal 100 has an access history for the AP 200, step 501 may be omitted. Furthermore, step 507 in which the AP 200 determines the “OPEN” communication state and step 509 in which the AP 200 outputs a message according to a communication state may be omitted according to the policy of the AP 200 as described above with reference to FIG. 4. Accordingly, it may be understood that a major method of operating the mobile terminal 100 includes the processes of sending the message for the key code conversion request to the AP 200 and, when the conversion key code is received from the AP 200, accessing the AP 200 again based on the received conversion key code.

Meanwhile, in the above description, an example in which one mobile terminal 100 requests the AP 200 to convert a key code and the conversion of the key code and relevant operations are performed has been described, but exemplary embodiments of the present invention are not limited thereto. That is, the conversion key code of the AP 200 may be shared among a plurality of mobile terminals, and the plurality of mobile terminals may send data and signals to the AP 200 based on the conversion key code. To this end, the AP 200 may be set to send the conversion key code to designated mobile terminals.

Furthermore, each of a plurality of mobile terminals may generate a unique conversion key code along with the AP 200 through the above process and share the unique conversion key code with the AP 200. When data and signals are received from a specific mobile terminal, the AP 200 may determine whether a conversion key code corresponding to the specific mobile terminal exists. If, as a result of the determination, the conversion key code corresponding to the specific mobile terminal exists, the AP 200 may support wireless communication with the specific mobile terminal based on the conversion key code. To this end, the AP 200 may store conversion key codes, corresponding to respective mobile terminals, in the AP storage unit 250 and manage the conversion key codes. If an operator who operates the AP 200 sets the AP 200 so that it can perform wireless communication with one mobile terminal 100, the AP storage unit 250 may store only one conversion key code value corresponding to the one mobile terminal 100.

Meanwhile, the mobile terminal 100 may further include elements not described above, such as a local area communication module for local area communication, a camera module for photographing still images and moving images of a subject as described above, an interface for enabling the mobile terminal 100 to send and receive data according to a wired communication method or a wireless communication method, an Internet communication module for performing an Internet function over an Internet network, and a digital broadcasting module for performing a function of receiving and playing digital broadcasting. The elements may not be all enumerated because they are modified in various ways according to the convergence trend of digital devices, but elements equivalent to the above-described elements may be further added to the terminal. Furthermore, it is to be noted that the mobile terminal 100 may omit some of the elements from the configuration or may replace some of the elements with other elements. This may be easily understood by a person having ordinary skill in the art.

Furthermore, the mobile terminal 100 may include all types of devices which support a data communication function enabling access to the AP 200. For example, the mobile terminal 100 may include all mobile communication terminals which are operated in accordance with communication protocols corresponding to various communication systems, all information communication devices and multimedia devices, such as a Portable Multimedia Player (PMP), a digital broadcasting player, a Personal Digital Assistant (PDA), a music player (e.g., a Motion Pictures Expert Group (MPEG)-1 or MPEG-2 Audio Layer-3 (MP3) player), a handheld game terminal, a smart phone, a notebook computer, and a handheld Personal Computer (PC), and application devices for the information communication devices and multimedia devices.

In accordance with the security operation system and method for an AP according to the exemplary embodiments of the present invention, a key code used in the security of an AP is converted through a simple control operation. Accordingly, more robust communication against hacking or data snipping can be supported.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A security operating method for an Access Point (AP), the method comprising:
sending, by a mobile terminal, a key code conversion request message to the AP;
generating, by the AP, a conversion key code in response to the key code conversion request message;
sending, by the AP, the generated conversion key code to the mobile terminal; and
accessing, by the mobile terminal, the AP based on the received conversion key code.

2. The method of claim 1, further comprising:
accessing, by the mobile terminal, the AP; and
storing, by the AP, an access history of the mobile terminal.

3. The method of claim 2, wherein the generating of the conversion key code comprises generating a new key code based on the access history of the mobile terminal and a stored encryption algorithm by the AP.

4. The method of claim 3, wherein the generating of the conversion key code comprises generating the conversion key code by the AP based on a Media Access Control (MAC) address of the mobile terminal and at least one of time information about a time when the mobile terminal accesses the AP and time information about a time when the mobile terminal sends the key code conversion request message.

5. The method of claim 1, further comprising:
setting the AP into an OPEN communication state before sending the key code conversion request message; and
determining, by the AP, whether the mobile terminal has an access history after receiving the key code conversion request message.

6. The method of claim 5, wherein, if the communication state of the AP is in any one of a Wired Equivalent Privacy (WEP) encryption communication state, a Wireless-Fidelity (Wi-Fi) Protected Access (WPA) encryption communication state, and a WPA2 encryption communication state, the accessing of the AP by mobile terminal is restricted according to the setting state of the AP, and further wherein the mobile terminal sends a signal or data to the AP only when the signal or data is encrypted based on a key code suitable for relevant encryption.

7. The method of claim 5, wherein the generating of the conversion key code comprises generating the conversion key code by the AP, when the mobile terminal has the access history.

8. The method of claim 7, further comprising maintaining an access state by the mobile terminal and the AP before sending the key code conversion request message,
wherein the key code conversion request message is a message in which the mobile terminal requests access to the AP.

9. The method of claim 1, further comprising storing, by the mobile terminal, the conversion key code or updating a previously stored key code value into the conversion key code.

10. A security operation system for an Access Point (AP), the system comprising:
a mobile terminal for generating a key code conversion request message, for sending the key code conversion request message to the AP, and, when a conversion key code corresponding to the key code conversion request message is received from the AP, for attempting access to the AP based on the conversion key code; and
the AP for generating a new conversion key code in response to a key code conversion request of the mobile terminal and for sending the new conversion key code to the mobile terminal.

11. The system of claim 10, wherein the AP comprises:
an AP input unit for changing a communication state of the AP;
an AP communication unit for performing communication with the mobile terminal;
an AP storage unit for storing an encryption algorithm for a security operation and an access history of the mobile terminal; and
an AP controller for, when the key code conversion request is received from the mobile terminal, generating the new conversion key code based on the encryption algorithm and sending the new conversion key code to the mobile terminal.

12. The system of claim 11, wherein the AP communication unit is set in at least one of an OPEN communication state, a Wired Equivalent Privacy (WEP) encryption communication state, a Wireless-Fidelity (Wi-Fi) Protected Access (WPA) encryption communication state, and a WPA2 encryption communication state.

13. The system of claim 11, wherein the AP controller generates the conversion key code of the encryption algorithm based on the access history of the mobile terminal.

14. The system of claim 13, wherein the AP controller parses Media Access Control (MAC) address information and at least one of time information about a time when the mobile terminal accesses the AP and time information about a time when the mobile terminal sends the key code conversion request message from the access history of the mobile terminal and performs control so that the new conversion key code is generated based on at least one of the MAC address information and the at least one piece of information.

15. The system of claim 10, wherein the mobile terminal maintains an access state with the AP before sending the key code conversion request message to the AP, writes a message to request access to the AP as the key code conversion request message, and sends the written message to the AP.

16. The system of claim 10, wherein the mobile terminal comprises a terminal storage unit for storing the new conversion key code and updating a previously stored key code value into the conversion key code.

17. The system of claim 10, wherein the AP generates a conversion key code for each of a plurality of mobile terminals and stores and manages the generated conversion key codes.
